(19) United States
(12) Patent Application Publication
(10) Pub. No.: US 2023/0166468 A1
(43) Pub. Date: Jun. 1, 2023

(54) LINING ELEMENT OF A CURING MOLD FOR A TIRE COMPRISING SIPE BLADES

(71) Applicant: COMPAGNIE GENERALE DES ETABLISSEMENTS MICHELIN, Clermont-Ferrand (FR)

(72) Inventors: DAMIEN BARDIN, Clermont-Ferrand (FR); ALEKSANDER ROMAN, Clermont-Ferrand (FR); DARIUSZ KONOBROCKI, Clermont-Ferrand (FR); PAUL LACOSTE, Clermont-Ferrand (FR)

(21) Appl. No.: 17/910,666

(22) PCT Filed: Mar. 8, 2021
(86) PCT No.: PCT/FR2021/050383

§ 371 Date: Sep. 9, 2022

(30) Foreign Application Priority Data
Mar. 10, 2020 (FR) FR2002358

(51) Int. Cl. B29D 30/06

(52) U.S. Cl. CPC B29D 30/0606; B29D 2030/0613

(57) ABSTRACT

A lining element (16) of a curing mold (10) for a tire forms a molding surface (14), the molding surface comprising recessed and protruding patterns, at least one first protruding pattern (30) being formed by a first sipe blade (32) with a cross section in the form of a fork (34), and at least one second protruding pattern (36) being formed by a second sipe blade (38) and by a bulge (40) extending along a radially internal contour (42) of the second sipe blade, at least one recessed pattern being partially delimited by at least one first protruding pattern (30) and at least one second protruding pattern (36).

The present invention relates to the manufacture of tyres and more particularly to the field of curing moulds that are used during a step of curing a tyre.

The manufacture of a tyre comprises a curing step, during which a green tyre is moulded and vulcanized so as to obtain a tyre having given mechanical characteristics, geometry and appearance. The tyre is cured in a curing mould. The green tyre is pressed against the mould so as to mould the internal surface of the mould on said green tyre and thus to form the external surface of the tyre. In particular, the mould comprises a lining intended to form a tread pattern on the tread of the tyre.

The moulding surface of the lining has recessed and protruding patterns. The protruding patterns are generally formed by sipe blades that are intended to form furrows with a thickness greater than 2 mm in the tread pattern of the tyre. The furrows allow, in particular, good evacuation of the water when the tyre is running on wet ground. In a known way, the sipe blades extend circumferentially and/or transversely over the radially internal surface of the lining, and cross so as to form and to delimit, on the tread pattern of the tyre, protruding patterns with a parallelepipedal shape, generally known as “blocks”.

In order to improve the performance of the tyre, the lining comprises moulding elements in the form of sipe blades with a thickness of up to 2 mm. The sipe blades form, on the tread pattern of the tyre, voids that partially or entirely cut through a block. A void thus makes it possible to improve the grip of the tyre while maintaining good stiffness of the tread, thereby making it possible in particular to limit dissipations of energy.

The application WO2010039148, in the name of the applicant, discloses a tyre, the tread pattern of which comprises voids with a cross section in the shape of a fork. In other words, a void extends radially from the surface of the tread that is in contact with the ground toward the interior of the tread, and the splits in two. The forked part of the void is intended to open onto the surface of the tread that is in contact with the ground when said tread has reached a certain level of wear. Such a void makes it possible to restore the grip of the tyre when it has reached a certain level of wear, while limiting the number of voids in the new state, this making it possible to maintain good stiffness of the tread.

However, the sipe blades known as “Y-shaped” sipe blades that make it possible to obtain such voids have significant undercuts that make them problematic to demould, in particular on account of the risk of the blocks being pulled out of the tread pattern. The problem is all the more difficult given that, to restore the grip effectively, the forked part of the void needs to have a sufficient spacing, this increasing the risk of the blocks being pulled out of the tread pattern.

An objective of the invention is to overcome the drawbacks of the prior art and to provide an original solution for making it easier to demould a lining having Y-shaped sipe blades, while improving the performance of the tyre.

To this end, the invention provides a lining element of a curing mould for a tyre, forming a moulding surface, the moulding surface comprising recessed and protruding patterns. At least one first protruding pattern is formed by a first sipe blade with a cross section in the form of a fork. At least one second protruding pattern is formed by a second sipe blade and by a bulge extending along a radially internal contour of the second sipe blade. At least one recessed pattern is partially delimited by at least one first protruding pattern and at least one second protruding pattern.

The second pattern moulds a channel embedded in the tread of the tyre, and a void that opens into said channel. The channel makes it possible to improve the performance of the tyre. For example, the channel is intended to open onto the surface of the tread when the latter reaches a certain level of wear, and makes it possible to restore the water draining capability of the tyre. It is thus possible to reduce the depth or the number of furrows in the new state. Moreover, the voids make it possible, in the new state, to maintain good stiffness of the tread, thereby making it possible in particular to limit dissipations of energy. Lastly, the channel into which the void opens makes it possible to eliminate stress concentrations in the bottom of the void and thus to reduce the risks of the rubber blocks being pulled out while the tyre is running.

Furthermore, combining a first pattern and a second pattern to mould the blocks of a tyre tread pattern also makes it possible to improve the performance of said tyre, in particular when its tread has reached a certain level of wear. The channel provides the tread with flexibility and helps to maintain the grip of the tyre. For example, the designers found that a tyre moulded in this way made it possible to achieve a more advantageous compromise between performance aspects of grip and drainage than a tyre in which the blocks have only simple voids or voids with a fork-shaped cross section.

Lastly, the achievement of such a compromise between performance aspects makes it possible to reduce the spacing of the forked part of the first sipe blade and thus to reduce the undercuts in the moulding surface of the lining. The risk of the blocks of the tread pattern of the tyre being pulled out while it is being demoulded is thus limited.

Preferably, the first protruding pattern and the second protruding pattern intersect. The tread moulded in this way is more flexible, and the risk of the blocks of the tread pattern of the tyre being pulled out while it is being demoulded is thus limited.

Advantageously, the recessed pattern is substantially in the form of a parallelepiped that is delimited by at least one first protruding pattern and a pair of second protruding patterns, the first protruding pattern intersecting a second protruding pattern at each of its ends. Such an arrangement makes it possible to improve the drainage performance of the tyre. In addition, the risk of the blocks of the tread pattern of the tyre being pulled out while it is being demoulded is limited.

Preferably, the thickness of the bulge of the second protruding pattern is less than 60% of the thickness of the fork of the first protruding pattern, more preferably less than 50% and even more preferably less than 40%. Thus, the undercuts of the moulding surface of the lining are limited and the risk of the blocks of the tread pattern of the tyre being pulled out while it is being demoulded is also limited.

Advantageously, the height of the bulge of the second protruding pattern is between 50% and 200% of the height of the fork of the first protruding pattern, and more preferably between 70% and 150%.

Preferably, the bulge of the second protruding pattern and the fork of the first protruding pattern overlap radially at most over 50% of their height, and more preferably at most over 30% their height. Such an arrangement makes it possible to reduce the rolling of the vulcanized rubber when the lining element is removed from the tread of the tyre. Thus, the risk of the blocks of the tread pattern of the tyre being pulled out while it is being demoulded is limited.

Advantageously, the first protruding pattern delimits a first recessed pattern, and the second protruding pattern forms an intersection with the first protruding pattern, the intersection partially delimiting at least one second recessed pattern, the second recessed pattern protruding with respect to the first recessed pattern, the lining element having a moulding element designed to fill the second recessed pattern.

Preferably, said moulding element is integral with the first sipe blade.

According to a second subject, the invention provides a method for manufacturing a tyre, comprising a step of curing in a curing mould for a tyre having a lining element according to the invention.

According to a third subject, the invention provides a tyre intended to be mounted on the rim of a wheel, characterized in that it is obtained by a manufacturing method according to the second subject of the invention.

The invention will be understood better from the remainder of the description, which is based on the following figures:

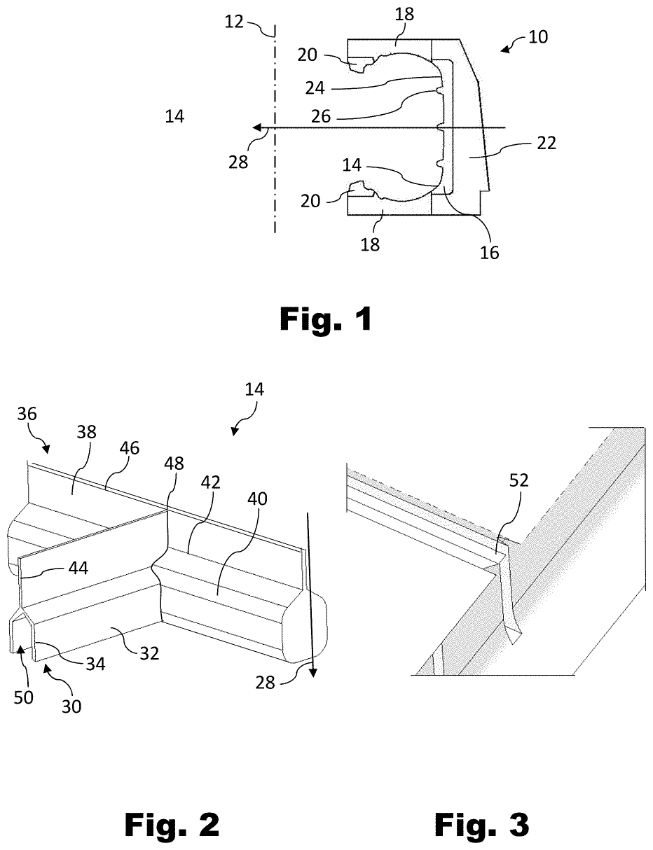

FIG. 1 is a view in radial section of certain elements of a curing mould;

FIG. 2 is a perspective view of certain elements of the lining of the mould in FIG. 1,

FIG. 3 is a perspective view of a part of the tread of a tyre that has reached a certain level of wear, said part having been moulded by the elements in FIG. 2;

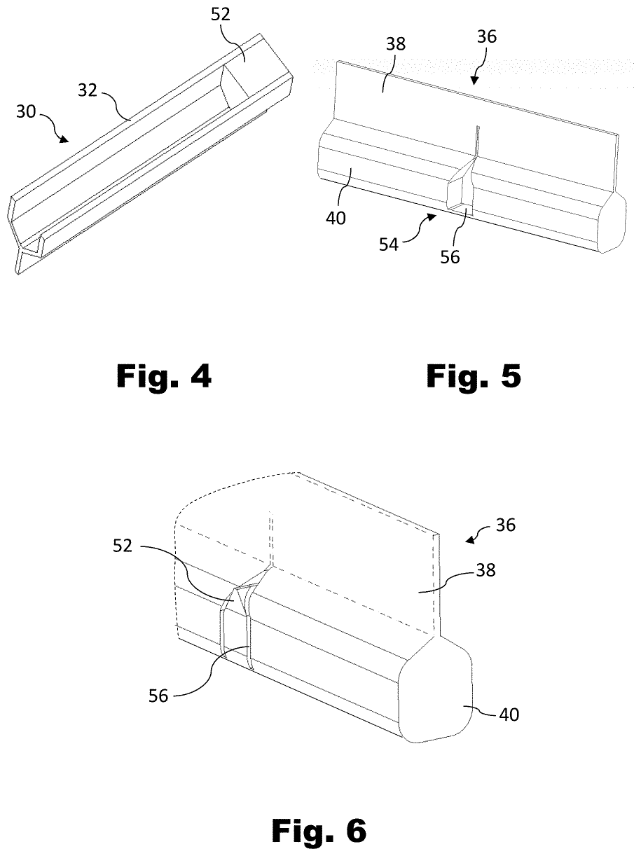

FIG. 4 is a perspective view of certain elements of the lining of the mould in FIG. 1, according to a first variant of the invention;

FIG. 5 is a perspective view of certain elements of the lining of the mould in FIG. 1, according to a second variant of the invention;

FIG. 6 is a perspective view of certain elements of the lining of the mould in FIG. 1, according to a second variant of the invention.

In the various figures, elements that are identical or similar bear the same reference signs. Their description is therefore not systematically repeated.

FIG. 1 schematically illustrates a curing mould 10 for a tyre, used for moulding and vulcanizing a green tyre, in order to obtain a tyre with a desired geometry and appearance. The mould delimits an interior space that is generally rotationally symmetric about a central axis 12. The curing mould comprises a frame, moulding elements, vulcanization means, and means for opening and closing the mould. The opening and closing means are able to set the moulding elements in movement between an open position and a closed position (FIG. 1). The open position corresponds to the step of withdrawing a moulded and vulcanized tyre, and to the step of introducing a new green tyre. The closed position corresponds to the step of moulding and vulcanizing the green tyre. The vulcanization means are able to provide the thermal energy and pressure that are required, respectively, for the vulcanization and the moulding of the green tyre. By way of example, thermal energy and pressure are provided by pressurized steam circulating about the mould, and inside the green tyre in an extendable membrane. In the closed position of the mould, the moulding elements form a moulding surface 14 corresponding to the negative of the desired external surface of the tyre. The moulding elements more particularly comprise a lining 16 intended to mould the tread of the tyre, two shells 18 intended to mould the sidewalls of the tyre, and two rings 20 intended to mould the beads of the tyre.

The lining 16 bears on a ring 22 of the mould with its radially external surface. The lining generally comprises a plurality of circumferentially disposed lining elements. By way of example, a lining element has a plurality of sipe blades, a body and possible inserts. A sipe blade is a thin moulding element. The sipe blade has a moulding part, the thickness of which varies generally from 0.2 to 2 mm for a tyre intended to be mounted on a passenger vehicle, and an anchoring part that is able to be submerged in the body of the lining element. By way of examples, a sipe blade is obtained by a material removing process such as laser cutting, a plastic deformation process such as pressing, an additive manufacturing process such as consolidation by selective melting, or by a combination of these processes. Preferably, a lining element is obtained by a casting process involving overmoulding the body of the lining element about the anchoring part of the sipe blades, or by manufacturing the body of the lining element by way of an additive manufacturing process, after which said body is joined to the sipe blades. The joining of the sipe blades to the lining body so as to produce a lining element may be effected by a screwed assembly process, an adhesive bonding process, a welding process, or by any other suitable joining process. Lastly, a lining element may be obtained by an additive manufacturing process in which the body of the lining element and the moulding part of the sipe blades are produced integrally.

The moulding surface of the lining 16 has recessed patterns 24 and protruding patterns 26. A “pattern” means the shape of a part of the moulding surface of the lining, or the shape corresponding to a part of the tread pattern of a tyre. A pattern has a technical and/or aesthetic function.

The moulding surface of the lining is circumscribed by an exterior template of substantially cylindrical or toric shape, known as a “crown form”. The protruding patterns extend radially from the crown form towards the interior of the mould. A radial direction 28 is a direction perpendicular to the central axis 12 of the mould. By way of example, the protruding patterns are in the form of parallelepipeds, circumferentially and/or transversely extending furrows, or are in the form of sipe blades or of spikes. The protruding patterns entirely or partially delimit, on the moulding surface, recessed patterns. By way of example, the recessed patterns have prismatic shapes or extend circumferentially and/or transversely along a polygonal section.

FIG. 2 illustrates a part of the moulding surface of the lining 16. According to the invention, at least one first protruding pattern 30 is formed by a first sipe blade 32 with a cross section in the form of a fork 34, and at least one second protruding pattern 36 is formed by a second sipe blade 38 and by a bulge 40 extending along a radially internal contour 42 of the second sipe blade.

The first sipe blade, known as a Y-shaped sipe blade, comprises two moulding parts. A first part with a section in the form of a stem 44 extends from the crown form 46 towards the interior of the mould, and a second part, extending and dividing the stem, with a section in the form of arms 34. By way of example, the second part has two arms. The height, measured in the radial direction 28, of the first part is less than 10 mm and preferably less than 7 mm. The height of the second part is between 2 mm and 10 mm and preferably between 2 mm and 7 mm. The thickness, measured in a circumferential or transverse direction, of the second part or, in other words, of the fork is between 2 mm and 10 mm and preferably between 2 mm and 7 mm. A circumferential or transverse direction is perpendicular to the radial direction 28 and, respectively, orthogonal or parallel to the central axis 12.

The bulge 40 is arranged along the radially internal contour 42 of the second sipe blade 38. The section of the bulge has various shapes and is delimited by a contour of rounded, polygonal, convex or concave shape. By way of example, the bulge is integral with the second sipe blade 38. The height of the second sipe blade is between 2 mm and 20 mm and preferably between 2 mm and 14 mm. The thickness of the bulge is understood as being the section of the bulge which is comprised in a circular template with a diameter of between 2 mm and 20 mm and preferably between 2 mm and 7 mm.

Preferably, the thickness of the bulge of the second protruding pattern is less than 60% of the thickness of the fork of the first protruding pattern, more preferably less than 50% and even more preferably less than 40%. The height of the bulge of the second protruding pattern is between 50% and 200% of the height of the fork of the first protruding pattern and more preferably between 70% and 150%. The bulge of the second protruding pattern and the fork of the first protruding pattern overlap radially at most over 50% of their height and more preferably at most over 30% of their height.

At least one recessed pattern of the lining 16 is substantially in the form of a parallelepiped or, in other words, of a 6-faced polyhedron, the opposite faces of which are substantially parallel. Preferably, the moulding surface 14 comprises a plurality of said recessed patterns, which are distributed uniformly over the entirety of said moulding surface. At least 20% of said recessed patterns and preferably at least 50% of said recessed patterns are partially delimited by at least one first protruding pattern 30 and at least one second protruding pattern 36. Preferably, the first protruding pattern and the second protruding pattern intersect. Preferably, said recessed patterns are delimited by at least one first protruding pattern and a pair of second protruding patterns, the first protruding pattern intersecting a second protruding pattern at each of its ends.

The protruding patterns 26 may form intersections 48. In a radial view of the lining, an intersection is delimited by a contour surrounding the superposed parts of each protruding pattern. Consequently, the expression “intersection of protruding patterns” is not understood to mean the regular parts, or parts outside said contour, of the intersecting protruding parts, but is understood to mean at least the singular parts and the superposed parts of said patterns. The regular parts of the protruding patterns are the parts in which the radial profile thereof is not impacted by the intersection of the protruding patterns.

The first protruding pattern 30 delimits a first recessed pattern 50, and the second protruding pattern 36 forms an intersection 48 with the first protruding pattern. The first protruding pattern 30 and the first recessed pattern 50 have a longitudinal shape. The intersection 48 partially delimits at least one second recessed pattern (not shown). The second recessed pattern protrudes with respect to the first recessed pattern and forms a tongue 52 (FIG. 3), the thickness of which at the middle of the tongue is less than 5 mm and more preferably less than 2.5 mm. The lining element has a moulding element designed to fill the second recessed pattern.

According to a first variant illustrated in FIG. 4, the moulding element 54 is integral with the first sipe blade 32. The second sipe blade 36 and the bulge 38 have assembly means 54 in the form of a slot 56 into which the first sipe blade is intended to be inserted (FIG. 5).

According to a second embodiment variant illustrated in FIG. 6, the moulding element 52 is integral with the second sipe blade 38 and the bulge 40.

Further variants and embodiments of the invention may be envisaged without departing from the scope of these claims.

1.-8. (canceled)

9. A lining element (16) of a curing mold (10) for a tire, forming a molding surface (14), the moulding surface comprising recessed and protruding patterns,
at least one first protruding pattern (30) being formed by a first sipe blade (32) with a cross section in the form of a fork (34), and
at least one second protruding pattern (36) being formed by a second sipe blade (38) and by a bulge (40) extending along a radially internal contour (42) of the second sipe blade,
at least one recessed pattern being substantially in a parallelepiped form that is delimited by at least one first protruding pattern (30) and a pair of second protruding patterns (36), the first protruding pattern intersecting a second protruding pattern at each of its ends.

10. The lining element according to claim 9, wherein a thickness of the bulge (40) of the second protruding pattern is less than 60% of the thickness of the fork (34) of the first protruding pattern.

11. The lining element according to claim 9, wherein a height of the bulge (40) of the second protruding pattern is between 50% and 200% of the height of the fork (34) of the first protruding pattern.

12. The lining element according to claim 9, wherein the bulge (40) of the second protruding pattern and the fork (34) of the first protruding pattern overlap radially at most over 50% of their height.

13. The lining element according to claim 9, wherein the first protruding pattern (30) delimits a first recessed pattern (50), and the second protruding pattern (36) forms an intersection (48) with the first protruding pattern, the intersection partially delimiting at least one second recessed pattern, the second recessed pattern protruding with respect to the first recessed pattern, the lining element having a molding element (52) designed to fill the second recessed pattern.

14. The lining element according to claim 13, wherein the molding element is integral with the first sipe blade (32).

15. A method for manufacturing a tire, the method comprising:
curing in a curing mold (10) for a tire having the lining element according to claim 9.

16. A tire intended to be mounted on a rim of a wheel, wherein the tire is obtained by the manufacturing method according to claim 15.
